(19) United States
(12) Patent Application Publication
(10) Pub. No.: US 2005/0018330 A1
(43) Pub. Date: Jan. 27, 2005

(54) Reflection mirror and rear projection type image display apparatus

(75) Inventors: Megumi Sakoo, Yokohama (JP); Sadayuki Nishimura, Yokohama (JP); Koji Hirata, Yokohama (JP); Kei Adachi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/859,858

(22) Filed: Jun. 2, 2004

(30) Foreign Application Priority Data
Jun. 5, 2003 (JP) 2003-160665

(51) Int. Cl. G02B 5/08

(52) U.S. Cl. 359/884

(57) ABSTRACT

An object of the present invention is to obtain corrosion resistance performance which is more excellent than that of a conventional reflection mirror. To achieve the object, according to the invention, in a reflection mirror 30 having a metal plating film 2 and a top-coat layer 3 on a flat surface of a base plate 1, a silver reflection film 2 is formed by metal plating on the flat surface of the base plate 1. After that, by removing the reflective film on the side face of the base plate 1 or preventing the reflective film from being formed on the side face of the base plate 1 from the beginning, the side portion of the junction face between the base plate 1 and the reflective film 2 is completely covered with the top-coat film 3.

### CLAIM OF PRIORITY

The present application claims priority from Japanese application serial no. 2003-160665, field on Jun. 5, 2003, the content of which is hereby incorporated by reference into this application.

### BACKGROUND OF THE INVENTION

The present invention relates to a reflection mirror as a front surface mirror for reflecting toward a screen a projection image beam from an image projector for emitting an image beam, which is used to reduce the thickness of a rear projection type image display apparatus. Particularly, the invention relates to a reflection mirror in which a reflective film forming a reflection surface is formed by a metal thin film, and a top-coat is formed by using a colorless transparent resin as a protective film of the metal thin film, a method of manufacturing the same, and a rear projection type image display apparatus using the reflection mirror.

Hitherto, on a rear projection type image display apparatus, a reflection mirror for reflecting a projection image beam from an image projector for emitting an image beam toward a screen is mounted. As the reflection mirror, generally, a reflection mirror obtained by forming a metal reflective film made of aluminum metal by vacuum evaporation, vacuum sputtering, or the like as a vacuum film forming process on the surface of a glass base plate and forming a reflection-enhanced film by a transparent inorganic material on the metal reflective film is often used. As such conventional techniques, for example, a technique disclosed in Japanese Laid-Open No. 2001-235798 (Patent Document 1) is known.

However, the reflection mirror used for a rear projection type image display apparatus has a large size and a film forming apparatus such as a sputtering system is expensive. Since the work efficiency of formation of films by vacuum evaporation, vacuum sputtering, or the like is low, the price of the reflection mirror is also high.

Although it is not used for the reflection mirror, as other methods of forming a metal reflective film, particularly, a reflective film of silver having a high reflection coefficient, except for the vacuum evaporation method and the vacuum sputtering method, a spray method using a silver mirror reaction which occurs when a metallic-salt-contained solution and a reducing-agent contained solution are sprayed to an object to be plated, thereby plating the object is proposed (refer to, for example, Japanese Laid-Open No. 2001-295059 (Patent Document 2)). There is also an electrolytic plating method. Unlike the vacuum evaporation, vacuum sputtering, and the like, those methods do not require an expensive facility at the time of forming a metal reflective surface.

However, silver is chemically unstable and is easily corroded by steam in atmosphere and other small-amount harmful components such as acid vapor. By forming a top-coat as a protective film on the reflective film of silver, the reflective film of silver is protected from corrosion and the like.

As methods of improving corrosion resistance of the silver reflective film, laminated members having a base plate, a base coat film, a silver plating film, and a top-coat film are known (refer to, for example, Japanese Laid-Open No. 2002-256455 (Patent Document 3)).

At the time of manufacturing the laminated members, first, a base coat agent is applied on the surface of the base plate, thereby forming a base coat film. After that, by using a silver mirror reaction, the surface of the base coat film is covered with a silver plating film. By performing a thermal process or ultrasound process on the silver plating film, a micro crack is formed. After that, a top-coat agent is applied on the surface of the silver plating film, thereby forming a top-coat film. According to the method, by intentionally forming a micro crack, in the case where corrosion occurs locally in silver, the corrosion is prevented from spreading in the whole silver plating film (in the horizontal direction) and corrosion resistance performance of a plated product can be improved.

In a back-surface mirror for a bathroom having a silver reflective film, in which a back coating film for preventing corrosion is formed on the rear face of a glass base plate, to prevent an exposed portion of the silver reflective film at a silver edge from being corroded, the edge portion is coated (refer to, for example, Japanese Laid-Open No. 11-128041 (Patent Document 4)).

### SUMMARY OF THE INVENTION

In the reflection mirror disclosed in the patent document 1 and the laminated members having the silver plating film disclosed in the patent document 3, corrosion resistance from the top surface of a product is considered but prevention of corrosion from the side face of the product is not sufficiently considered.

For example, in the reflection mirror used for the projection type image display apparatus, aluminum having reflectance lower than that of silver is used as the metal material of the reflective film from the viewpoint of corrosion resistance. Consequently, the reflective film is exposed from the side face of the reflection mirror.

In the laminated members having the silver plating film disclosed in the patent document 3, it is feared that silver is corroded when chloride ions invade between the top-coat film and the silver plating film from the silver exposed portion in the side surface. For example, when a salt-spray test (JIS Z2371) is conducted, salt water enters a junction face between the base plate and the top-coat film and corrosion progresses as the salt water permeates. Consequently, it is assumed that the micro crack cannot stop such progress of corrosion.

In the method of preventing corrosion in the silver reflective film at the edge by applying a film on the edge, which is disclosed in the patent document 4, as obvious from FIG. 1 of the patent document 4, the film is applied only the edge, so that the film thickness of this portion increases. Consequently, the method cannot be applied to a front surface mirror requested to have a uniform reflection characteristic.

The inventors herein prototyped a reflection mirror, as a reflection mirror for use in a rear projection type image display apparatus, obtained by forming a silver reflective film having reflectance higher than that of aluminum on the top face of the glass base plate by using a silver mirror reaction in order to reduce the cost, and forming a transparent protective film on the silver reflective film. The inventors herein examined corrosion resistance of the prototyped reflection mirror and, as a result, found that corrosion in the silver reflective film progresses from the side face and the top-coat film peels off in a process of conducting the salt-spray test.

The cause is considered that the side face of the glass base plate is not sufficiently alkaline-washed. Specifically, the side face of the glass base plate is not sufficiently alkaline-washed, so that adhesion of the reflective film formed on the side face is weak. Even when a top-coat film is formed not only on the top face of the glass base plate but also the side face, the top-coat film on the side face partly peels off. As a result, it is considered that corrosion starts from the portion from which the top-coat film peels off.

The present invention has been achieved in consideration of the problems and the results of examination of the inventors. An object of the invention is to provide a reflection mirror realizing high corrosion resistance while reducing the cost by preventing corrosion from the side face, a method of manufacturing the same, and a rear projection type image display apparatus using the reflection mirror.

To achieve the object, according to the invention, a reflection mirror used for a rear projection type image display apparatus for projecting a video image beam from an image projector by reflecting the video image beam toward a screen is characterized by including at least: a base plate made of glass; a reflective film of silver serving as a reflective surface formed on the base plate; and a top-coat made of a transparent resin formed on the reflective film.

The reflective film is formed only on the surface of the base plate on the side the image beam is incident, and the top-coat is formed at least in a predetermined range in the side face of the base plate so as to cover the side face of the reflective film. The reflection film is formed by a silver mirror reaction. Further, the side portion of the junction face between the base plate and the reflective film is covered with the top coat.

Since the reflective film is not provided on the side face of the glass base plate, corrosion from the side face can be reduced. In addition, the reflective film is not formed by vacuum film formation but is formed by the silver mirror reaction. Thus, the cost can be reduced.

### BRIEF DESCRIPTION OF THE DRAWINGS

FIG. 1 is a cross section schematically showing the structure of a reflection mirror according to a first embodiment of the invention;

FIG. 2 is a flowchart for explaining a method of manufacturing the reflection mirror shown in FIG. 1;

FIGS. 3A, 3B, and 3C are diagrams each showing an intermediate state after an air blow process in step S16 in FIG. 2;

FIG. 4 is a cross section schematically showing the structure of a reflection mirror as a comparative example;

FIG. 5 is a cross section schematically showing the structure of a reflection mirror according to a second embodiment of the invention; and

FIG. 6 is a cross section showing the configuration of a rear projection type image display apparatus on which the reflection mirror is mounted.

### DETAILED DESCRIPTION OF THE PREFERRED EMBODIMENTS

Embodiments of a reflection mirror according to the invention and a rear projection type image display apparatus using the reflection mirror will be described in detail hereinbelow with reference to the drawings.

### FIRST EXAMPLE

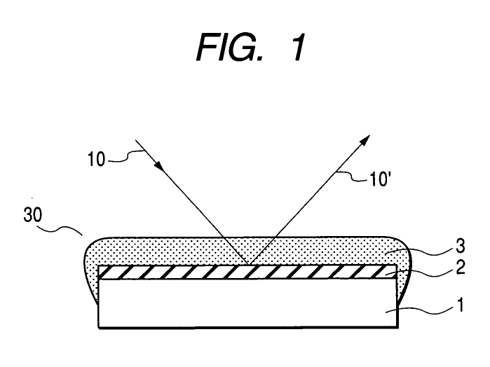

FIG. 1 is a cross section illustrating the structure of a reflection mirror according to a first embodiment of the invention. In FIG. 1, a reflection mirror 30 has a base plate 1 having a flat surface, a reflective film 2 formed on the flat surface of the base plate 1, and a top-coat 3 as a protective film for covering the surface of the reflective film 2 and preventing the reflective film 2 from corrosion. The top-coat 3 extends to the side face and completely covers the side of the junction face between the base plate 1 and the reflective film 2.

The base plate 1 having the flat surface is made of glass in the embodiment but the material is not limited to glass. Any plate having high precision of a flat surface may be used. The reflective film 2 is a thin film of silver having high reflectance and is formed on the flat surface of the plate by the silver mirror reaction. The top-coat 3 as a protective film is made of a colorless transparent resin.

The reflective film 2 is formed by a so-called silver mirror reaction of causing a redox reaction by applying an ammoniacal silver nitrate solution and a reducing agent solution by, for example, a spray method so as to be mixed on the flat surface of the base plate 1, thereby depositing silver on the surface of the base plate. At this time, silver is deposited to the thickness of 50 to 100 nm. By using the silver mirror reaction, the reflection mirror can be provided at low cost without requiring an expensive facility such as a vacuum film forming apparatus or the like.

The top-coat 3 is formed by applying a top-coat agent on the surface of the reflective film 2 or immersing the surface of the reflective film 2 in the top-coat agent and drying the top-coat agent. An example of the top-coat agent is an acrylic resin. Since application by spraying is easy, a liquid-mixtures type acrylic urethane resin is suitably used. When spraying is used, an applying work is facilitated and the cost can be reduced.

Incident light 10 entering the reflection mirror 30 having such a configuration passes through the top-coat 3, is reflected by the reflective film 2, passes the top-coat 3 again, and goes out as reflection light 10′.

As obviously understood from FIG. 1, the reflective film 2 is not exposed from the side face of the reflection mirror 30 as the first embodiment, and the top-coat 3 is formed by being extended to the base plate 1 so that the side of the junction face between the base plate 1 and the reflective film 2 in the side face is completely covered with the top-coat 3.

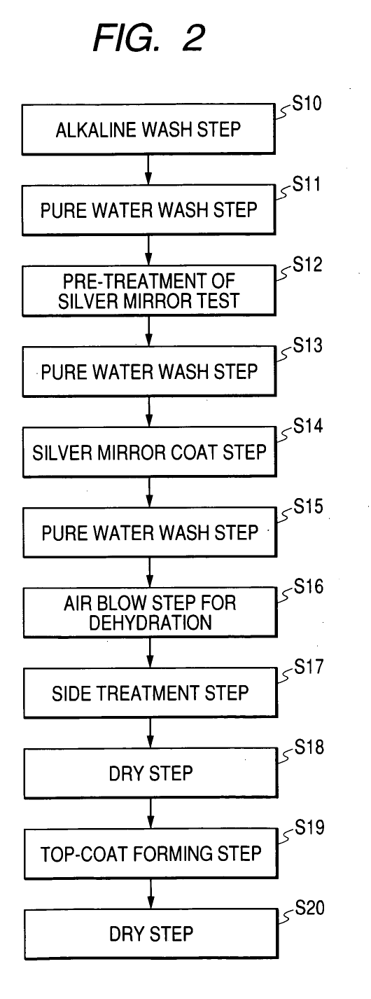

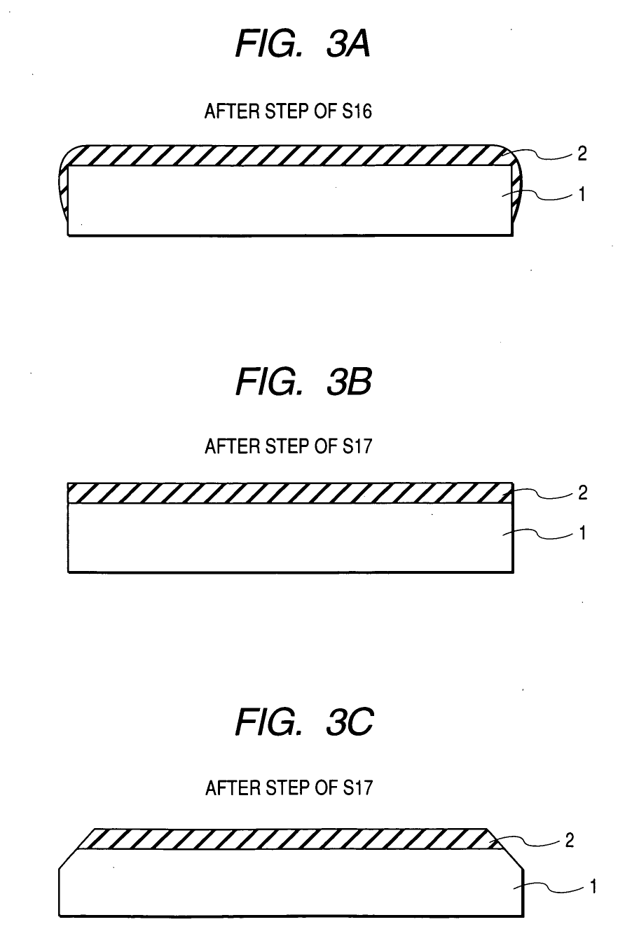

A method of manufacturing the reflection mirror according to the invention will now be described by referring to FIG. 2 and FIGS. 3A to 3C. FIG. 2 is a flowchart showing processes of the method of manufacturing the reflection mirror according to the invention. FIG. 3A is a diagram showing an intermediate state after an air blow process for dehydration in step S16 in FIG. 2. FIGS. 3B and 3C are diagrams each showing an intermediate state after a side treatment process in step S17 in FIG. 2.

At the time of manufacturing the reflection mirror constructed as described above, in FIG. 2, first, the flat surface of the glass base plate 1 is alkaline-washed (step S10). Subsequently, the flat surface of the glass base plate 1 is washed with pure water (step S11). By the process, impurities on the flat surface of the base plate 1 are removed and adhesion between the base plate and the reflective film of silver plating is increased.

Subsequently, as a pre-treatment step of silver mirror reaction, a stannic chloride (SnCl₄) solution of 2 to 3% is applied to the flat surface of the base plate 1 washed with pure water or the flat surface is immersed in the stannic chloride (SnCl₄) solution of 2 to 3%, thereby allowing tin to be absorbed by the flat surface of the base plate 1 (step S12). After that, the remained stannic chloride (SnCl₄) which is not absorbed is removed by using pure water (step S13).

After that, a silver mirror coating process is performed (step S14). In the silver mirror coating process, by simultaneously applying an ammoniacal silver nitrate solution and a reducing agent solution on the flat surface of the base plate 1 washed in step S13, thereby causing a reaction between the solutions on the surface of the base plate 1 and depositing silver. When the spray method described in the patent document 2 is used and the solutions are applied by using a two headed spray gun in the silver mirror coating process, workability improves. Further, the deposited silver is absorbed by the surface of the base plate 1 and is laminated while being substituted with tin absorbed by the surface of the base plate 1, thereby forming a silver plating film as the reflective film 2.

Subsequently, the surface of the silver plating film (reflective film 2) is washed with pure water to remove the solutions remained after the silver mirror reaction, tin remained after substitution, and the like (step S15). Then, by blowing compressed air (air blow) to the surface of the silver plating film (reflective film 2), an air blow step for draining is made (step S16).

After that, a process of treating the side of the base plate 1 is performed (step S17). At the time of forming the reflective film 2, the stannic chloride (SnCl₄) solution flows to the side face of the base plate 1 in the pre-treatment of silver mirror reaction in step S12, and the ammoniacal silver nitrate solution and the reducing agent solution (hereinbelow, the stannic chloride solution and the ammoniacal silver nitrate solution will be generically called a plating solution) flow to the side face of the base plate 1 in the silver mirror coat process in step S14, so that not only the top face of the base plate 1 but also the side face are silver-plated as shown in FIG. 3A. The plating is wiped off with cloth or the like to thereby expose the side face of glass as shown in FIG. 3B. Although the plating is generally wiped off by cloth, the invention is not limited to the method. It is also possible to obliquely cut the side face to expose the base plate 1 as shown in FIG. 3C.

After the side treatment in step S17, a drying process of drying the base plate 1 at 70° C. for 20 minutes is performed (step S18) and a top-coat forming process is performed (step S19). The top-coat forming process is a process for forming a film of the top-coat material 3 made by a top-coat agent on the surface of the reflective film 2. In the top-coat forming process, first, the top-coat agent is applied uniformly on the surface of the silver plating layer (reflective film 2) so that the silver plating layer (reflective film 2) does not expose and so as to cover the side face of the base plate 1. After that, the resultant is dried at 140° C. for ten minutes in the drying process (step S20). In such a manner, the top-coat 3 covering the surface of the reflective film 2 and the side face of the base plate 1 is formed, and the reflection mirror 30 whose junction face between the base plate and the reflective film is not exposed is completed.

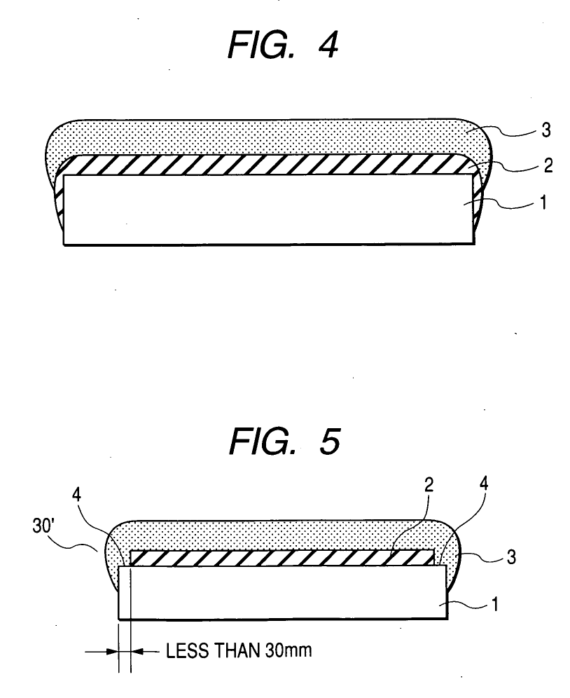

FIG. 4 shows a reflection mirror in which the reflective film is formed on the side face of the base plate 1 manufactured by omitting the side treatment process of step S17 in FIG. 2 and whose effects are to be compared with the effects of the present invention. The reflection mirror will be called a comparative reflection mirror hereinbelow.

The reflection mirror of the first embodiment and the comparative reflection mirror were subjected to a corrosion test in accordance with the method of salt water spray test conformed with JIS Z 2371. Specifically, a sample was placed still in a test apparatus in which a sodium chloride solution of 5% was maintained at 35° C. and sprayed, and a progress state of corrosion was seen and a checked.

A test result will be described. First, corrosion started from the side face and gradually expanded to the inside. In the comparative reflection mirror, corrosion reached to a place which is 20 mm or more from the side face after 24 hours. In the reflection mirror of the invention, no corrosion occurred even after lapse of 96 hours and reflectance of the reflection film did not drop.

The factors that the comparative reflection mirror is easily corroded from the side face are considered as follows. Since the side face of the glass base plate is not sufficiently alkaline-washed, the adhesion of the reflective film formed when the top-coat agent flows to the side surface of the glass base plate is weak. Even when the top-coat is formed on not only the top face of the glass base plate but also the side face, the top-coat on the side face peels off partially and corrosion starts from the peeled portion.

In contrast, the reflection mirror according to the invention is constructed so that the reflective film on the side face, which is formed since the plating solution flows to the side face, is wiped off by cloth or the like. After that, the reflective film is top-coated with the top-coat agent so as not to be exposed in the surface. Consequently, contact with air of the silver plating layer is prevented, so that corrosion of the silver plating layer (reflective film) from the side face in which corrosion easily occurs is reduced, and the reflection mirror having high corrosion resistance can be obtained.

Since an expensive facility such as a vacuum evaporation system is not necessary for forming the silver reflective film, the reflection mirror can be provided at low cost.

In the above, the unintended reflective film on the side face formed when the plating solution flows to the side face of the base plate is wiped off in the silver mirror coat process, thereby removing the reflective film. However, in a place (glass base plate side face) where the stannic chloride solution (SnCl₄) flowered to the side face of the base plate is adhered to the base plate in the portion where there is no dirt on the surface of the side face of the glass base plate and the ammoniacal silver nitrate solution and the reducing agent solution which flowed to the side face of the base plate are mixed well, the redox reaction occurs normally, and silver is deposited, adhesion between the glass base plate and the reflective film is high. Therefore, in such a place, there is a case that the reflective film cannot be sufficiently wiped off, and the reflective film remains in a patchy pattern. In this case, however, by forming a top-coat so as to extend to the side face of the base plate 1 and cover the junction face between the base plate and the reflective film, the silver reflective film remained in the patchy pattern on the side face does not peel off since the adhesion with the glass base plate is strong. Therefore, corrosion from the side face can be reduced.

### SECOND EXAMPLE

A second embodiment of the invention will now be described. The first embodiment is characterized in that the base plate is exposed by removing the reflective film of silver plating formed on the side face. The second embodiment is characterized in that the base plate is masked in advance so that silver plating (reflective film) is not formed on the side face of the base plate. The method of masking the base plate and removing the mask after the silver mirror coat process can realize lower manufacturing cost than the method of forming the silver plating (reflective film) and removing the silver plating (reflective film) on the side face.

FIG. 5 is a diagram showing the second embodiment. In FIG. 5, the same reference numerals are designated to the same components as those in FIG. 1 and their description will not be repeated here. As obvious from FIG. 5, in a reflection mirror 30′ of the second embodiment, the reflective film 2 is not formed not only on the side face but also a front margin 4 of the base plate 1 on which the reflective film is to be formed.

The reflection mirror 30′ is manufactured as follows. In FIG. 2, before the alkaline wash process in step S10, the side face of the base plate 1 is masked. The masking allowable range of the front margin 4 that masking can be performed at the peripheral portion of the top face of the base plate 1 is set to a predetermined range of, for example, less than 30 mm and, preferably, less than 20 mm. Specifically, there is the possibility that the reflective film is not formed in the portion of less than 30 mm from the edge of the base plate 1. However, there is no problem since a fixing piece hides about 20 mm from the edge when the reflection mirror is mounted on the rear projection type image display apparatus. In the side treatment process in step S17, the mask is removed. Except for that, the same processes as those in FIG. 2 are performed, thereby manufacturing the reflection mirror shown in FIG. 5.

The salt-spray test was also conducted in the second embodiment in a manner similar to the first embodiment and a superiority difference from the first embodiment was not seen.

The effects displayed by the second embodiment are similar to those of the first embodiment and, in addition, the work of wiping off the reflective film 2 formed on the side face in FIG. 2 does not have to be done. Consequently, the process can be simplified and the manufacturing cost can be suppressed. Even when the periphery of the base plate 1 of the reflection mirror obtained by the method is cut off, the side of the junction face between the base plate 1 and the reflective film 2 is covered with the top-coat 3. Thus, effects similar to those of the reflection mirror shown in FIG. 5 can be produced.

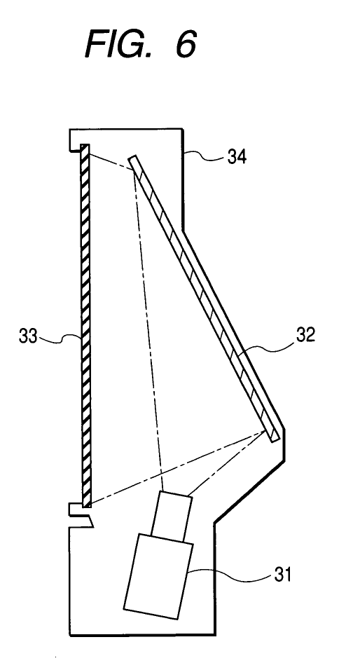

FIG. 6 is a configuration cross section seen from the side face, showing an embodiment of the rear projection type image display apparatus on which the reflection mirror is mounted. In FIG. 6, reference numeral 31 denotes an image projector. As a representative image projector, a 3 tubes-type projection cathode-ray tube can be mentioned. Alternately, an optical unit for forming an optical image according to a video signal by modulating light intensity by an image device and enlargedly projecting the optical image by projecting means may be employed. 32 denotes a reflection mirror according to the invention, 33 denotes a screen, and 34 indicates a housing of the rear projection type image display apparatus.

In the rear projection type image display apparatus, a projected image beam from the image projector 31 is projected onto the reflection mirror 32 and reflected by the reflection mirror 32 so that the optical path is changed toward the screen, and a projected image is displayed on the screen 33 from the rear side.

By using a reflection mirror having excellent corrosion resistance subjected to the side face process according to the invention for the rear projection type image display apparatus, the rear projection type image display apparatus capable of suppressing corrosion of the silver reflective film for long time, preventing corners of an image from becoming dark and preventing display of an image from being interrupted, and in which brightness, contrast, and resolution do not easily deteriorate can be obtained.

Although glass is used as the base material of the reflection mirror in the above, the invention is not limited to glass. For example, as the base material, a plastic resin or the like may be used. If the surface precision of the surface of plastic resin is insufficient, obviously, an under coat layer may be provided to improve the precision of the flat surface and the silver reflective film may be provided on the under coat layer.

As described above, the reflection mirror of the invention includes a base plate having a flat surface, a reflective film of silver constructing a reflective surface formed on the flat surface of the base plate, and a top-coat made of a transparent resin formed on the reflective film. By covering the side of the junction face between the base plate and the reflective film with the top-coat, the reflection mirror in which corrosion of the silver reflective film from the side of the junction face is prevented can be manufactured at low cost. By not providing the reflective film on the side face of the base plate, corrosion from the side face can be suppressed. Thus, the reflection mirror having excellent corrosion resistance and the rear projection type image display apparatus using the reflection mirror can be provided.

1. A reflection mirror used for a rear projection type image display apparatus for projecting a video image beam from an image projector by reflecting the video image beam toward a screen, comprising:
a base plate having a flat surface;
a reflective film of silver serving as a reflective surface formed on the flat surface of the base plate; and
a top-coat made of a transparent resin formed on the reflective film,
wherein a side portion of a junction face between said base plate and said reflective film is covered with said top-coat.

2. The reflection mirror according to claim 1, wherein said reflective film is a silver reflective film formed by a silver mirror reaction on the flat surface of the base plate.

3. The reflection mirror according to claim 1, wherein said reflective film is formed only on the flat surface of said base plate on the side said image beam is incident, and said top-coat is formed at least in a predetermined range in the side face of said base plate so as to cover the side portion of the junction face between said base plate and said reflective film.

4. The reflection mirror according to claim 1, wherein said reflective film is formed only on the flat surface of said base plate on the side said image beam is incident and in a region out of a predetermined distance range from an end face of the base plate.

5. The reflection mirror according to claim 1, wherein said reflective film is formed only on the flat surface of said base plate on the side said image beam is incident and in a region out of a distance range of 30 mm or less from the end surface of said base plate.

6. The reflection mirror according to claim 1, wherein the material of said top-coat is an acrylic resin.

7. A rear projection type image display apparatus for projecting a video image beam from an image projector by reflecting the video image beam toward a screen by a reflection mirror, and having a holding part for holding said reflection mirror, said reflection mirror comprising:
a base plate having a flat surface;
a reflective film of silver serving as a reflective surface formed on the flat surface of the base plate; and
a top-coat made of a transparent resin formed on the reflective film,
wherein said silver reflective film is formed only on the flat surface of said base plate on the side said image beam is incident and in a region out of a predetermined distance range from an end face of the base plate, and
the predetermined distance range from the end face of the base plate is almost the same as a holding range of said holding part or includes the holding part.

8. A method of manufacturing a reflection mirror used for a rear projection type image display apparatus, comprising:
a reflective film forming step of forming a reflective film of silver on a flat surface of a base plate;
a top-coat forming step of forming a top-coat as a protective film by a transparent resin on said reflective film;
a step of removing said reflective film formed incidentally in the reflective film forming step on the side face of said glass base plate; and
a forming step of forming said reflective film.

9. A method of manufacturing a reflection mirror used for a rear projection type image display apparatus for projecting an image beam from an image projector by reflecting the image beam toward a screen, comprising:
a masking step of masking at least a predetermined range on the side face of the glass base plate so that a reflective film is formed only on the top face of said glass base plate on the side said image beam is incident;
a reflective film forming step of forming a reflective film of silver on the glass base plate; and
a top-coat forming step of forming a top-coat as a protective film by a transparent resin on the reflective film.

10. The method of manufacturing a reflection mirror according to claim 8 or 9, wherein said reflective film forming step is a step of forming said reflective film of silver by a silver mirror reaction using a spray method.

11. A rear projection type image display apparatus for projecting an image beam from an image projector by reflecting the image beam by a reflection mirror toward a screen, said reflection mirror including:
a base plate having a flat surface;
a reflective film of silver serving as a reflective surface formed on the flat surface of the base plate; and
a top-coat made of a transparent resin formed on the reflective film,
wherein a side portion of a junction face between said base plate and said reflective film is covered with said top-coat.

12. A rear projection type image display apparatus using a reflection mirror manufactured by the method of manufacturing a reflection mirror according to claim 8 or 9.
